(19) United States
(12) Patent Application Publication
(10) Pub. No.: US 2022/0013312 A1
(43) Pub. Date: Jan. 13, 2022

(54) VACUUM LOAD BREAK SWITCH FOR PERFORMING VACUUM MAKING/BREAKING AND ISOLATION OPERATION IN A SINGLE STROKE

(71) Applicant: SCHNEIDER ELECTRIC INDUSTRIES SAS, Rueil Malmaison (FR)

(72) Inventors: Abhijit DESHMUKH, Whitefield (IN); Deepak Raorane, Karnataka (IN)

(21) Appl. No.: 17/343,931

(22) Filed: Jun. 10, 2021

(30) Foreign Application Priority Data
Jul. 7, 2020 (IN) 202031028832

(51) Int. Cl. H01H 33/666; H01H 33/664

(52) U.S. Cl. CPC H01H 33/6661; H01H 2033/6667; H01H 33/664

(57) ABSTRACT

Embodiment herein provide a vacuum Load break switch comprising a tank (Metallic or non-metallic) (1), an interruption system (2) enclosed in the tank (1), a drive lever (3) connected to the interruption system (2), a leak proof system (4) with multiple O-Rings connected to the interruption system (2), and a source side connector (5) and a load side connector (6) connected to the interruption system (2). During an open operation, a current inside the vacuum interruption system (2) is interrupted to move the interruption system (2) and create an isolation distance. Further, during a close operation, the vacuum interruption system (2) moves to make the isolation distance zero and then the current flow is started inside vacuum interruption system (2).

### FIELD OF THE INVENTION

The present disclosure relates to medium voltage and high-voltage circuit breakers, and more particularly relates to a vacuum Load break switch (also refereed as breaker or recloser) for performing vacuum making/breaking and isolation operation using a single stroke of a control handle.

### BACKGROUND OF THE INVENTION

Load break switch as well as circuit breaker or recloser are widely used in various electrical field and are one of the main types of switching equipment used in the distribution of electrical energy. The main requirements for switch/breaker is to make/break the load current (active or reactive) and short circuit current as well as isolate the distribution section whenever required.

There is a wide variety of designs of Load break switch. SF6 filled switches are commonly used as Load break switch which is having breaking as well as isolation capability. Vacuum interrupters have been used for load-break switches in the prior art but is not used for isolation because the vacuum interrupter cannot provide isolation between two contacts. This is one of the main restrictions of not using the vacuum making/breaking in the conventional Load break switch. Successful breaking in vacuum interrupter can be achieved in less gap which is not enough for isolation. If we try to integrate isolation and breaking in vacuum interrupter then it brings mechanical as well as manufacturing constraint which makes it impossible to adopt both the requirements. Isolation distance ensures no electrical conduction between contacts at worst environmental conditions like surges on network ensuring safe operation for operator.

Former approaches allow the making/breaking operation inside the conventional Load break switch for creating the isolation gap. There is a wide variety of designs of load switches such as SF6, made on the basis of various methods of extinguishing an electric arc. But the SF6 making/breaking is less preferred environmentally because of hazardous biproducts of SF6 disintegration. SF6 is also a potent greenhouse gas with a high global warming potential. Also making/breaking inside SF6 degrades the quality of SF6 reducing the life of the equipment. So there is drive to reduce use of SF6 in transmission and distribution equipment.

With the change of environmental guideline and awareness, there remains a need of a robust vacuum load break that can be used for making/breaking and isolation operation.

The principal object of the embodiments herein is to provide a vacuum Load break switch for performing vacuum making/breaking and isolation operation in a single stroke of electrical control as well as manual operation through an electrical control or by manual handle of the vacuum Load break switch.

### SUMMARY OF THE INVENTION

In one aspect the object is satisfied by providing a vacuum Load break switch comprising a tank (Metallic or nonmetallic), an interruption system enclosed in the tank, a drive lever connected to the interruption system, a leak proof system with multiple O-Rings connected to the interruption system, and a source side connector and a load side connector connected to the interruption system. During an open operation, an electrical current inside vacuum interruption system is interrupted by vacuum system and then the interruption system moves further to create an isolation distance. This isolation distance is made visible by providing a viewing window on the tank.

Further, during a close operation, the vacuum interruption system move back to remove the isolation distance first and then contacts inside vacuum interrupter system closes in vacuum to resume the electrical current flow.

In an embodiment, during the open operation both the current inside the vacuum interruption system is interrupted and the isolation distance is created in a single stroke of operation through an electrical control or by a manual handle of the vacuum interruption system.

In an embodiment, during the close operation the vacuum interruption system move back to remove the isolation distance first and then contacts inside vacuum interrupter system closes in vacuum to resume the electrical current flow in a single stroke of operation through an electrical control or by a manual handle of the vacuum interruption system.

In an embodiment, the current is one of a normal load current and a short circuit current.

In an embodiment, the interruption system comprises a bush load side, a voltage measurement system connected to the bush load side, a shock absorbing medium, a movable rod connected to the open spring, a bottom fixed cover, bellows, a drive holder, an insulation cover, a movable contact, a fixed contact, a top fixed cover, a bush source side. The voltage measurement system measures continuous voltage and send the measured voltage to a processing unit. It helps to integrate the monitoring and protection schemes. The shock absorbing medium absorbs shocks during the open operation and the close operation of the vacuum interruption system. The movable rod ensures making/breaking inside the vacuum interrupter and isolation can be achieved outside the vacuum interrupter. Moving and fixed contacts can be interchanged to achieve isolation on either side of vacuum interrupter. The bottom fixed cover seals vacuum inside the interruption system and allow the movable rod to open fixed distance/stroke during the open operation of the interruption system. The drive holder transmits a linear motion of the drive lever to the vacuum interruption system. The drive lever ensures sufficient movement/stroke of vacuum interruption system compressing open spring to achieve required contact force. The insulation cover provides an insulation between the source side connector and the load side connector. The movable contact enables making and breaking of the current. The fixed contact fixed to the moveable contact to receive the current in closed condition. The fixed rod fixed to the fixed contact to make or break or carry the current.

In an embodiment, the open spring outside the vacuum interrupter does not allow movement the movable contact during the movement of interruption system until the interruption system opens completely during the open operation.

In an embodiment, the open spring outside the vacuum interrupter retains the movable contact in open condition inside the vacuum interrupter until the isolation distance is covered during the close operation.

In an embodiment, the close operation is completed when the movable contact touches the fixed contact of the bush source side applying required contact pressure thereby removing the isolation distance.

In an embodiment, the open spring outside the vacuum interrupter acts as a contact loading spring once the close operation is complete.

In an embodiment, the bush load side and the bush source side is provided on both side of the interruption system to hold the voltage measurement system, the source side connector and the load side connector.

In an embodiment, the shock absorbing medium can be achieved using elastic material like elastomers or spring system or oil damping system.

In an embodiment, the bottom fixed cover keeps the vacuum interrupter in a sealed condition to retain vacuum inside the vacuum interrupter. It also provides the seat for open spring and controls the stroke of movable rod.

In an embodiment, the bellows provides flexibility to the vacuum interrupter to allow the movable rod during the open operation of the interruption system.

In an embodiment, the drive holder connects the vacuum interrupter with the drive lever.

In an embodiment, the insulation cover make a sealing container for the vacuum interrupter.

In an embodiment, the insulation cover acts as an interface between the vacuum interrupter with drive holder.

In an embodiment, the insulation cover provides a firm grip to the drive holder.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

The proposed vacuum Load break switch is illustrated in the accompanying drawings, throughout which like reference letters indicate corresponding parts in the various figures. The embodiment herein will be better understood from the following description with reference to the drawings, in which:

FIG. 1 illustrates a vacuum Load break switch for performing vacuum making/breaking and isolation operation using a single stroke, according to embodiment as disclosed herein;

FIG. 2 illustrates an interruption system of the vacuum Load break switch, according to embodiment as disclosed herein; and

FIG. 3 illustrates a section view of the interruption system, according to embodiment as disclosed herein.

### DETAILED DESCRIPTION OF THE INVENTION

The embodiment herein and the various features and advantageous details thereof are explained more fully with reference to the non-limiting embodiment that is illustrated in the accompanying drawings and detailed in the following description. Descriptions of well-known components and processing techniques are omitted so as to not unnecessarily obscure the embodiments herein. The term “or” as used herein, refers to a non-exclusive or, unless otherwise indicated. The examples used herein are intended merely to facilitate an understanding of ways in which the embodiment herein can be practiced and to further enable those skilled in the art to practice the embodiments herein.

The accompanying drawings are used to help easily understand various technical features and it should be understood that the embodiment presented herein is not limited by the accompanying drawings. As such, the present disclosure should be construed to extend to any alterations, equivalents and substitutes in addition to those which are particularly set out in the accompanying drawings.

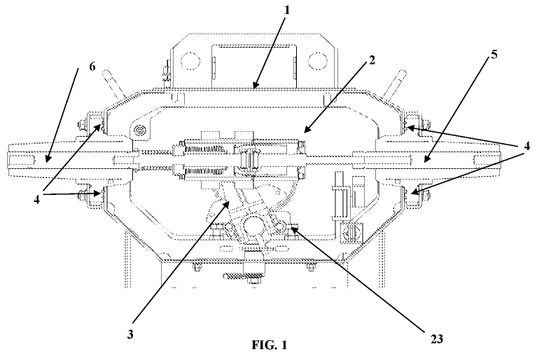

Referring now to the drawings, and more particularly to FIG. 1-3, there are shown preferred embodiment.

FIG. 1 illustrates a vacuum Load break switch for performing vacuum making/breaking and isolation operation using a single stroke, according to embodiments as disclosed herein.

The vacuum Load break switch comprising a tank (Metallic or non-metallic) (1), an interruption system (2) enclosed in the tank (1), a drive lever (3) connected to the interruption system (2), a leak proof system (4) with multiple O-Rings connected to the interruption system (2), and a source side connector (5) and a load side connector (6) connected to the interruption system (2). During an open operation, a current inside the vacuum interruption system (2) is interrupted inside the vacuum interrupter and then to move the interruption system (2) to create an isolation distance inside suitable dielectric gas. During the open operation both the current inside the vacuum interruption system (2) is interrupted and the isolation distance is created in a single stroke of operation through an electrical control or by manual handle of the Load break switch. Further, during a close operation, the interruption system (2) is moved back with contacts in open condition to remove the isolation distance first and then the contacts inside the vacuum interrupters are closed to restore the current flow. During the close operation both the isolation distance is removed and the current inside the vacuum interruption system (2) is started in a single stroke of operation through an electrical control or by manual handle of the Load break switch.

The proposed Load break switch integrates the vacuum making/breaking inside the Load break switch allowing to still get the isolation distance after making/breaking inside vacuum interrupter ensuring the operator safety. This isolation can be made visible by providing viewing window on the tank (1).

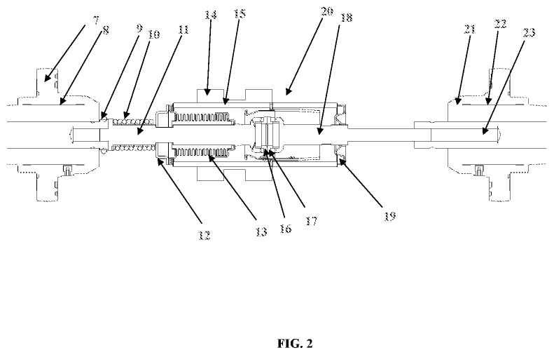

FIG. 2 illustrates an interruption system (2) of the vacuum Load break switch, according to embodiment as disclosed herein. The interruption system (2) comprises a bush load side (7), a voltage measurement system (8 and 22), a shock absorbing medium (9 and 23), an open spring (10), a movable rod (11), a bottom fixed cover (12), bellows (13), a drive holder (14), an insulation cover (15), a movable contact (16), a fixed contact (17), a fixed rod (18), a top fixed cover (19), a bush source side (21), and a vacuum interrupter (20).

The voltage measurement system (8 and 22) is connected to the bush load side (7) and is configured to measure continuous voltage and send the measured voltage to a processing unit. The bush load side (7) and the bush source side (21) is provided on both side of the interruption system (2) to hold the voltage measurement system (8 and 22), the source side connector (5) and the load side connector (6).

The shock absorbing medium (9 and 23) absorbs shocks during the open operation and the close operation of the vacuum interruption system (2). The shock absorbing medium (9 and 23) can be achieved using elastic material like elastomers or spring system or oil damping system.

The open spring (10) outside the vacuum interrupter (20) does not allow movement the movable contact (16) once the desire stroke of contact system is achieved until the interruption system (2) opens completely during the open operation. Further, the open spring (10) outside the vacuum interrupter (20) retain the movable contact (16) in open condition inside the vacuum interrupter (20) until the isolation distance is covered during the close operation. The current in close operation starts flowing when the movable contact (16) touches the fixed contract (17) of the bush source side (21) after removing the isolation distance. The drive lever (3) ensures sufficient movement/stroke of vacuum interruption system compressing open spring to achieve required contact force at the end of close operation.

The movable rod (11) connected to the open spring (10) which carries the current during the close operation of the interruption system (2) and allows the vacuum interrupter (20) to create the isolation distance during the open operation of the interruption system (2). In an embodiment, the current is one of a normal load current and a short circuit current.

The bottom fixed cover (12) seals the vacuum inside the interruption system (2). The bottom fixed cover (12) keeps the vacuum interrupter (20) in a sealed condition to retain vacuum inside the vacuum interrupter (20). It also helps to provide the seat for the open spring (10) and controls the stroke/contact gap of the movable rod (11).

The bellows (13) allows the movable rod (12) to open at the isolation distance during the open operation of the interruption system (2). The bellows (13) provides flexibility to the vacuum interrupter (20) to allow the movable rod (12) to open at the isolation distance during the open operation of the interruption system (2).

The drive holder (14) transmits a linear motion of the drive lever (3) to the vacuum interruption system (2). The drive holder (14) connects the vacuum interrupter (20) with the drive lever (3).

The insulation cover (15) provides an insulation between the source side connector (5) and the load side connector (6). The insulation cover (15) makes a sealing container for the vacuum interrupter (20). The insulation cover (15) acts as an interface between the vacuum interrupter (20) with drive holder (14). The insulation cover (15) provides a firm grip to the drive holder (14).

The movable contact (16) enables making and breaking of the current. The fixed contact (17) is fixed to the moveable contact to receive the current in closed condition. The fixed rod (18) is fixed to the fixed contact (17) to make or break or carry the current. The fix rod (18) slides on bush source side (21) during close and open operation without loosing contact with it keeping the electrical continuity between two.

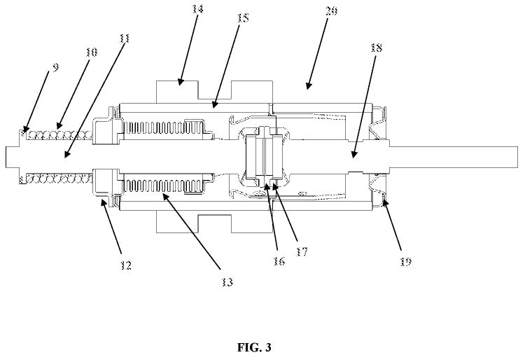

FIG. 3 illustrates a section view of the interruption system (2), according to embodiments as disclosed herein. Unlike the conventional Load break switch, the proposed invention allows first to break the current inside vacuum interrupter during opening operation. Once breaking of current happen inside vacuum interrupter, then the complete Vacuum interrupter moves and create isolation distance inside suitable dielectric gas. The spring outside the vacuum interrupter on moving conductor makes sure that the movable contact do not move or closes unless the vacuum interrupter opens completely. Both these operations (Breaking and Isolation) happen in a single stroke of operation through On-Off handle. Further, during close operation of the Load break switch, the proposed invention allows to operate the On-Off handle which allows the Load break switch to start the close operation. During the close operation, the vacuum interrupter moves towards bush load side in the open condition. The spring outside the vacuum interrupter on moving conductor make sure that the contacts remain in open condition inside vacuum interrupter. Once the movable contact touches the fixed terminal of bushing of load side, the isolation distance become zero and then the closing of vacuum interrupter contacts starts. Then the vacuum interrupter contacts touch completely and the current starts flowing through Load break switch. The drive lever ensures sufficient movement/stroke of vacuum interruption system compressing open spring to achieve required contact force. The complete operation of making isolation gap zero and then subsequently closing the vacuum interrupter happens in single operation of the On-Off handle.

Hence using the proposed invention, making/breaking happen inside the vacuum interrupter which is more efficient, increasing life of the product. The invention still gives the isolation distance inside Load break switch even though the making/breaking happens inside vacuum interrupter. This isolation can be made visible by providing viewing window on the tank.

The integration of the vacuum making/breaking along with getting isolation distance make the system more efficient because of efficient current breaking in vacuum and isolation in any other gas environment. Further, the proposed vacuum interrupter in three phase system is isolated with each other by normal/compressed air or by use if any gas or inert gas. Bringing all two functions of the vacuum making/breaking and the isolation distance inside one Load break switch and make them operational feasible is more efficient and thus increasing life of the product ensuring safety of operator. This also reduces the adverse effect on environment by eliminating usage of SF6 gas.

The As already mentioned, the foregoing description is illustrative of the invention and not limitative to its scope, because it will be apparent to persons skilled in the art to devise other alternative embodiments without departing from the broad ambit of the disclosure made herein

Following are the reference numerals:

| Numeral | Description |
|---|---|
| 1 | tank (Metallic or non-metallic) |
| 2 | interruption system |
| 3 | drive lever |
| 4 | leak proof system |
| 5 | source side connector |
| 6 | load side connector |
| 7 | bush load side |
| 8 | voltage measurement system |
| 9 | shock absorbing medium |
| 10 | open spring |
| 11 | movable rod |
| 12 | bottom fixed cover |
| 13 | bellows |
| 14 | drive holder |
| 15 | insulation cover |
| 16 | movable contact |
| 17 | fixed contact |
| 18 | fixed rod |
| 19 | top fixed cover |
| 20 | vacuum interrupter |
| 21 | bush source side |
| 22 | voltage measurement system |
| 23 | shock absorbing medium |

We claim:

1. A vacuum Load break switch comprising:
a tank (1);
an interruption system (2) enclosed in the tank (1);
a drive lever (3) connected to the interruption system (2);
a leak proof system (4) with multiple O-Rings connected to the interruption system (2); and
a source side connector (5) and a load side connector (6) connected to the interruption system (2),
wherein during an open operation, an electrical current inside the vacuum interruption system (2) is interrupted and the vacuum interruption system (2) is moves to create an isolation distance; and
wherein during a close operation, the vacuum interruption system (2) moves back to make the isolation distance zero and the contacts inside the vacuum interruption system (2) closes to resume the electrical current flow inside vacuum interruption system (2).

2. The vacuum Load break switch as claimed in claim 1, wherein during the open operation both the electrical current inside the vacuum interruption system (2) is interrupted and the isolation distance is created in a single stroke of operation through an electrical control or by a manual handle of the vacuum Load break switch.

3. The vacuum Load break switch as claimed in claim 1, wherein during the close operation both the isolation distance is removed and the electrical current inside the vacuum interruption system (2) is started in a single stroke of operation through an electrical control or by a manual handle of the vacuum Load break switch.

4. The vacuum Load break switch as claimed in claim 1, wherein the current is a load current or a short circuit current.

5. The vacuum Load break switch as claimed in claim 1, wherein the interruption system (2) comprises:
a bush load side (7);
a voltage measurement system (8 and 22) connected to the bush load side (7), wherein the voltage measurement system (8 and 22) measure continuous voltage and send the measured voltage to a processing unit;
a shock absorbing medium (9 and 23) to absorb shocks during the open operation and the close operation of the vacuum interruption system (2);
a movable rod (11) connected to the open spring (10), wherein the movable rod (12) carries the current during the close operation of the interruption system (2) and allows the vacuum interrupter (20) to create the isolation distance during the open operation of the interruption system (2);
a bottom fixed cover (12) to seal vacuum inside the interruption system (2), wherein the bottom fixed cover (12) provides seat for the open spring (10) and controls the gap between the contacts in the vacuum interruption system (2);
bellows (13) to allow the movable rod (12) to open at the isolation distance during the open operation of the vacuum interruption system (2);
a drive holder (14) to transmit controlled linear motion of the drive lever (3) to the vacuum interruption system (2) ensuring required contact force by compressing open spring (10);
an insulation cover (15) to provide an insulation between the source side connector (5) and the load side connector (6);
a movable contact (16) to enable making and breaking of the current;
a fixed contact (17) fixed to the moveable contact to receive the current in closed condition;
a fixed rod (18) fixed to the fixed contact (17) to make or break or carry the current;
a top fixed cover (19);
a bush source side (21); and
a vacuum interrupter (20).

6. The vacuum Load break switch as claimed in claim 5, wherein the open spring (10) outside the vacuum interrupter (20) does not allow movement the movable contact (16) until the interruption system (2) opens completely during the open operation.

7. The vacuum Load break switch as claimed in claim 5, wherein the open spring (10) outside the vacuum interrupter (20) retain the movable contact (16) in open condition inside the vacuum interrupter (20) until the isolation distance become zero during the close operation, wherein the open spring (10) provides required contact pressure on the contacts of the vacuum interrupter (20) in closed condition.

8. The vacuum Load break switch as claimed in claim 5, wherein the shock absorbing medium (9 and 23) is achieved using elastic material comprising elastomers or spring system or oil damping system.

9. The vacuum Load break switch as claimed in claim 5, wherein the bottom fixed cover (12) keeps the vacuum interrupter (20) in a sealed condition to retain the vacuum inside the vacuum interrupter (20), and wherein the bottom fixed cover (12) helps to provide the seat for the open spring (10) and controls the stroke/contact gap of the vacuum interrupter (20).

10. The vacuum Load break switch as claimed in claim 1, wherein the isolation distance is made visible by providing a viewing window on the tank (1).
